(19) United States
(12) Patent Application Publication
(10) Pub. No.: US 2016/0206996 A1
(43) Pub. Date: Jul. 21, 2016

(54) LIQUID SUPPLY SYSTEM FOR USE IN A VEHICLE

(71) Applicants: Jules-Joseph VAN SCHAFTINGEN, Wavre (BE); François DOUGNIER, Boortmeerbeek (BE); Pierre DE MAN, Bruxelles (BE); Beatriz MONGE-BONINI, Bruxelles (BE); PLASTIC OMNIUM ADVANCED INNOVATION AND RESEARCH, Bruxelles (BE)

(72) Inventors: Jules-Joseph VAN SCHAFTINGEN, Wavre (BE); Francois DOUGNIER, Boortmeerbeek (BE); Pierre DE MAN, Bruxelles (BE); Beatriz MONGE-BONINI, Bruxelles (BE)

(73) Assignee: PLASTIC OMNIUM ADVANCED INNOVATION AND RESEARCH, Bruxelles (BE)

(21) Appl. No.: 14/913,907

(22) PCT Filed: Sep. 4, 2014
(86) PCT No.: PCT/EP2014/068858

§ 371 Date: Feb. 23, 2016

(30) Foreign Application Priority Data
Sep. 4, 2013 (EP) 13182919.4

(51) Int. Cl. B01D 53/94; F01N 3/28; F01N 3/20

(52) U.S. Cl. CPC B01D 53/9431; F01N 3/2066; F01N 3/2896

(57) ABSTRACT

A liquid supply system for at least one ammonia-consuming unit mounted on board a vehicle, including: a container for storage of an ammonia precursor solution; at least one unit for storage of an aqueous ammonia solution containing at least 0.2% in weight of ammonia in water; and a mechanism supplying the aqueous ammonia solution to the ammonia-consuming unit.

The invention relates to a liquid supply system for use in a vehicle. In particular it relates to a liquid supply system for supplying liquid ammonia to ammonia-consuming units mounted on board a vehicle. For example, the ammonia-consuming unit may be a chemical process requiring ammonia such as an exhaust system which requires ammonia in order to carry out NOx reduction. The ammonia-consuming unit may also be a fuel cell system or an internal combustion engine.

In many mobile applications, particularly in vehicles, the only available technology is to use an ammonia precursor, for example an aqueous urea solution, since in this way potential hazards or safety issues relating to the transport of liquid ammonia are eliminated. However, there are several disadvantages related to the use of aqueous urea solution.

Some of these disadvantages will now be described, particularly in connection with SCR (Selective Catalytic Reduction) systems for vehicles, wherein aqueous urea solution is injected into the exhaust pipe.

Generally, SCR systems use aqueous urea solution, and in particular the eutectic solution containing 32.5 wt % urea in water, often referred to as AUS32.

Generally, such urea solution is stored in a container mounted on the vehicle. The urea solution is injected into the exhaust line, and the gaseous ammonia is derived from the pyrolytic (thermal) decomposition of the injected urea solution. In case of cold start, it is required to be able to operate the SCR system at the end of a predetermined period of time starting from the engine start, this predetermined period of time depending on the ambient temperature. It is generally used a heating device to liquefy the frozen urea solution in freezing conditions. However, even by doing so, it takes a while before enough urea solution is thawed and injected into the exhaust line. On the other hand, in order to avoid deposits in the exhaust pipe, and insure the required chemical reactions aqueous urea solution must not be injected in the exhaust pipe before the exhaust gases have raised the temperature of the exhaust pipe at a sufficient temperature, typically in the 180° C.-200° C. range. In consequence, control systems are designed so as to avoid premature injection of urea solution when the exhaust pipe is too cold, resulting in relatively poor NOx reduction performances in the first kilometres after start-up of the vehicles. Such circumstances are also encountered in some certification conditions.

In view of the above-mentioned disadvantages, there exists a need for an improved and secure system for supplying liquid ammonia, quickly enough especially at cold start.

### SUMMARY OF THE INVENTION

An object of the present invention is to solve the above-mentioned problems by proposing a liquid supply system for at least one ammonia-consuming unit mounted on-board a vehicle, comprising:
a container for the storage of an ammonia precursor solution;
at least one unit for the storage of an aqueous ammonia solution containing at least 0.2% in weight of ammonia in water;
means for supplying said aqueous ammonia solution to said ammonia-consuming unit.

The liquid supply system according to the invention is configured to provide (i.e. supply) aqueous ammonia for use in or by one or several ammonia-consuming unit(s) on-board a vehicle, such as an exhaust line, a combustion engine or a fuel cell.

The advantage of using aqueous ammonia solution, is that the aqueous ammonia solution remains available and active (i.e. ready to be supplied to the ammonia-consuming unit(s)) at temperatures at which the ammonia precursor solution is not available (generally because it is frozen).

In the particular case of SCR systems, the injection of aqueous ammonia solution instead of ammonia precursor solution in the exhaust pipe is advantageous due to the fact that the step of hydrolysis of the ammonia precursor is no longer to be performed in the exhaust pipe. This allows more compact design in the exhaust pipe: elimination of hydrolysis catalyst, reduced distance from injection point to SCR catalyst. The reactivity can further be improved by increasing the concentration of the aqueous ammonia solution by eliminating part of the water prior to metering into the exhaust pipe.

In an advantageous embodiment, the liquid supply system comprises means for supplying said ammonia precursor solution to said ammonia-consuming unit.

Thus, it is proposed a dual liquid supply system which combines the use of aqueous ammonia solution and ammonia precursor solution.

According to a particular embodiment of the invention, the aqueous ammonia solution and the ammonia precursor solution can be delivered (i.e. supplied) to an ammonia-consuming unit in an alternate manner (i.e. supply of one solution at a time). For example, in the particular case of SCR systems, supply of aqueous ammonia solution to the injector can take place when there is no ammonia precursor solution available in the container (generally either because said container is empty, or because the ammonia precursor solution is frozen, or because the line connecting the container (i.e. urea tank) to the exhaust pipe is too cold and introduction of ammonia precursor solution into this line would cause freezing). In another embodiment, the aqueous ammonia solution can be first supplied to the injector after the start of the engine so that NOx reduction can take place earlier than what could be done with the ammonia precursor solution, before eventually switching to the ammonia precursor solution. In another embodiment, aqueous ammonia solution is introduced in the line connecting the container (i.e. urea tank) to the exhaust pipe at the time the engine is stopped so as to avoid freezing of the content of the line when the line is filled with the ammonia precursor solution. Of course, the advantages listed for the above embodiments can be combined.

According to another particular embodiment, the aqueous ammonia solution and the ammonia precursor solution can be both supplied to the ammonia-consuming unit(s) in parallel (i.e. at the same time). For example, in the particular case of SCR systems, before the container containing the ammonia precursor solution is empty and if aqueous ammonia solution is available, then the aqueous ammonia solution can be metered in the exhaust gases while metering the ammonia precursor solution, so as to reduce the consumption of the remaining ammonia precursor solution while assuring adequate removal of NOx.

In a particular embodiment, the metering of the aqueous ammonia solution starts when the exhaust gases have raised the temperature of the exhaust pipe at a predetermined temperature, for example at 150° C.

As mentioned above, the aqueous ammonia solution can be first supplied after the start of the engine. In this particular embodiment, the aqueous ammonia solution is used as a start-up ammonia source. Thus, the start-up time of a SCR function can be reduced, especially in cold conditions, since a sufficient amount of aqueous ammonia solution is already available (i.e. aqueous ammonia solution stored in a liquid state in the unit) or simply because aqueous ammonia solution may be introduced at a lower temperature in the exhaust pipe than the ammonia precursor solution. In other words, in this particular embodiment, the unit containing the aqueous ammonia solution can be used as a start-up unit.

In another particular embodiment, the unit containing the aqueous ammonia solution can be used as a reserve unit.

In a first particular embodiment, the means for supplying the aqueous ammonia solution and the means for supplying the ammonia precursor solution can be distinct. For example, the system can comprise a first pump for supplying the aqueous ammonia solution and a second pump for supplying the ammonia precursor solution. In a second particular embodiment, the system can comprise a single pump for supplying both aqueous ammonia solution and ammonia precursor solution.

Advantageously, the means for supplying the aqueous ammonia solution and the means for supplying the ammonia precursor solution are controllable so as to supply an adequate amount of solution to the ammonia-consuming unit(s).

The ammonia precursor solution according to the present invention contains less than 0.2% in weight of ammonia in water.

In a particular embodiment, the ammonia precursor solution is an aqueous urea solution.

The terms “urea solution” are understood to mean any, generally aqueous, solution containing urea. The invention gives good results with eutectic water/urea solutions for which there is a quality standard: for example, according to the standard ISO 22241, in the case of the AdBlue® solution (commercial solution of urea), the urea content is between 31.8% and 33.2% (by weight) (i.e. 32.5+/−0.7 wt %) hence an available amount of ammonia between 18.0% and 18.8%. The present invention is particularly advantageous in the context of eutectic water/urea solutions, which are widely available in gas stations. It should be noted that it exists well known refilling standards and systems for ammonia precursor, in particular for the AdBlue® solution (commercial solution of urea). The refilling of the storage container of the ammonia precursor solution is trivial. For example, this can be achieved by using available standard-designed nozzle and/or bottles with dedicated interfaces. The Adblue® (commercial solution of urea) automotive fluid is currently readily available at numerous retail stations.

For clarity reason, the acronym “AUS32” will be used hereafter to designate the eutectic solution of 32.5 wt % urea in water.

The aqueous ammonia solution according to the present invention contains at least 0.2% in weight of ammonia in water. The aqueous ammonia solution according to the invention may contain aqueous urea solution or residue of aqueous urea solution, or carbon dioxide or carbon dioxide derivatives, or eventually combination of these.

For clarity reason, the acronym “AAUS” will be used hereafter to designate the aqueous ammonia solution according to the invention. For example, what we will refer to as AAUS22-0 is an aqueous ammonia solution containing 22% in weight of ammonia and 0% in weight of urea. In another example, what we will refer to as AAUS 19-4 is an aqueous ammonia solution containing 19% in weight of ammonia and 4% in weight of urea.

In a particular embodiment, the aqueous ammonia solution according to the invention is a mixture of effluents containing ammonium hydroxide (a fraction of which is ionized), residue of ammonia precursor (i.e. part of ammonia precursor that has not been decomposed) and eventually other products (such as ammonium hydrogen carbonate). Such mixture of effluents is also called hereafter “aqua ammonia”.

In a particular embodiment, the liquid supply system of the invention comprises means for obtaining said mixture of effluents by decomposing one part of the ammonia precursor solution stored in the container, for instance by means of at least one enzyme, such as urease, or optionally by thermal decomposition.

Thus, it is proposed an automatic in situ conversion (i.e. decomposition) of the ammonia precursor solution into aqueous ammonia solution. In other words, it is proposed a conversion of a first fluid-type reducing agent (for example, AdBlue®) into a second fluid-type reducing agent. This conversion takes place on board the vehicle. No external aqua ammonia source is used and no disassembly manual operations are needed for the refilling of the unit where aqua ammonia is stored. Thus, the production and the use of aqueous ammonia (such as the effluent also known as aqua ammonia) according to the invention are simple and safe.

In a preferred embodiment such means for obtaining said mixture of effluents (i.e. aqua ammonia) are in the form of a biochemical decomposition unit (i.e. biocatalysts).

According to a particular embodiment of the invention, the biochemical decomposition unit comprises at least one protein component adapted to decompose the ammonia precursor solution. This biochemical decomposition unit can store one or several protein component(s) that catalyze a chemical reaction. More precisely, in the particular case where the ammonia precursor solution is urea, the protein component(s) is(are) adapted to catalyze the hydrolysis (i.e. decomposition) of the urea into aqueous ammonia.

Advantageously, the bio-catalyzed decomposition occurs under mild temperature conditions and the products remain in solution (i.e. effluents), providing an easy way for vehicle storage, with a limitation of the generation of gaseous ammonia.

Advantageously, the protein component (stored in the biochemical decomposition unit) comprises at least one enzyme. In a preferred embodiment, the decomposition unit can store urease. Urease can be stored in any suitable manner. For example, in a first embodiment urease can be immobilized onto different polymers, or in different layers of resin. In a second embodiment urease can be fixed on membranes or on any other equivalent type of support. Advantageously, in this particular embodiment, the biochemical decomposition unit is equipped with a heater adapted to thermally activate the protein component(s). Such heater can provide the optimum temperature for the desired activity of the enzyme or protein. For example, the heater can be configured to maintain within the decomposition unit a temperature range between 20° C. and 70° C. Such temperature range is advantageous, since the decomposition unit (or the decomposition and storage unit) can be made of thermoplastic material. Advantageously, the decomposition unit (or the decomposition and storage unit) can be made by blow moulding or by injection moulding.

In a particular embodiment, the heater is a chamber whose temperature is controlled within predetermined ranges; in case the predetermined range falls below the temperature of the environment, cooling means will also be made available within the heater. In other words, the heater can either be controlled so as to rise up the temperature within the chamber or controlled so as to cool down the temperature within the chamber. In a particular embodiment, the heater is configured to work within at least one predetermined temperature range corresponding to the activation of the protein component when conversion is needed, and within at least another predetermined temperature range corresponding to the preservation of the protein component, so as to extend its lifetime.

In a particular embodiment of the invention, the heater can comprise resistive heating elements. These resistive heating elements may be metallic heating filaments (wires), flexible heaters, (that is to say heaters comprising one or more resistive track(s) affixed to a film or placed between two films (that is to say two substantially flat supports, the material and thickness of which are such that they are flexible)) or any other type of resistive elements that have a shape, size and flexibility suitable for being inserted into and/or wound around the components of the SCR system. PTC (Positive Temperature Coefficient) elements are more particularly suitable for heating.

In a first particular embodiment, the unit for the storage of aqueous ammonia solution is separated from the biochemical decomposition unit. In a second particular embodiment, the biochemical decomposition unit and the unit for the storage of aqueous ammonia solution form a unique decomposition and storage unit, i.e. module. This module can be entirely located inside the container (storing ammonia precursor solution). In a preferred embodiment, this module comprises an inlet through which ammonia precursor solution can enter.

In another particular embodiment, said unit comprises at least one refilling port being in fluid communication with a filler pipe. The filler pipe may cooperate with a filling interface which is accessible by a user from the outside of the vehicle.

Thus, the user can refill manually the unit(s) with aqueous ammonia solution.

Advantageously, said unit comprises at least one venting port being in fluid communication with a venting circuit.

In a further implementation thereof, the venting circuit comprises at least one of the following elements: an Over Pressure Relieve valve and an Under Pressure Relieve valve. The under pressure relieve valve is for instance calibrated for preservation of an under pressure in the unit for the aqueous ammonia solution, and particularly any vapour dome therein. Thus safety of the system is increased. Indeed, the Over Pressure Relieve valve (OPR) can be arranged such that it will evacuate some AAUS in the AUS32 in case of overpressure. In addition, the Under Pressure Relieve valve (UPR) can be arranged such that it will suck vapour in case of vacuum.

In another embodiment, the system comprises at least one line configured to transport said aqueous ammonia solution from said unit to the interior of the container, and controllable means for metering said aqueous ammonia solution in said at least one line.

Such line(s) can be used as a “thawing line”. More precisely, the aqueous ammonia solution (AAUS) can be injected into the container storing the ammonia precursor solution (AUS32), particularly at low temperatures, when the ammonia precursor solution is solid, and thus be used for thawing the solid ammonia precursor solution.

Advantageously, the unit containing the aqueous ammonia solution is located at least partially inside the container and/or on a wall of the container containing the ammonia precursor solution.

According to a preferred embodiment of the invention, said unit is entirely located inside the container containing the ammonia precursor solution.

Thus, the safety of the system is increased since, if a leak of aqueous ammonia solution occurs, the aqueous ammonia solution will be trapped in the container containing the ammonia precursor (for example, urea).

Advantageously, at least one part of said unit is flexible, for instance said at least one part of said unit is made of polymer such as polyethylene.

The unit for the storage of aqueous ammonia solution is delimited by walls. At least one of these walls can be flexible. Such a flexible wall may for instance be embodied by using an inert polymer of appropriate thickness. Suitable examples included polyolefines, such as polyethylene (monomer or copolymer, for instance HDPE), polypropylene, halogenated vinylpolymers, such as PVC and PVDF. This flexible wall turns out beneficial both at low and at high temperatures. At low temperatures, under conditions wherein the ammonia precursor solution freezes and therewith expands, the flexible wall may be deformed so as to allow more volume for the ammonia precursor solution. In such a manner, cracking of the container and/or damage to components within the container, such as a dosing unit, can be prevented, at least partially. At high temperatures, under conditions wherein the ammonia has a high vapour pressure, such as above room temperature, the flexible portion may be deformed so as to allow more space for the ammonia vapour.

Deformable units for aqueous ammonia solution also offer additional advantages: as the volume is variable, the amount of vapour above the aqueous ammonia solution can be reduced to a minimum. In addition, when the unit is located at least partially in the container, the space not used by the units (storing aqueous ammonia solution) can be recovered for storing more ammonia precursor solution. This is especially useful when the aqueous ammonia solution (i.e. aqua ammonia) is produced on-board by decomposition of the ammonia precursor solution: the space of the decomposed ammonia precursor solution can be mostly recovered to store the aqua ammonia resulting from the decomposition.

According to a further embodiment, the system comprises means for determining the volume of aqueous ammonia solution stored in said unit and the volume of ammonia precursor solution stored in the container. Such means for determining the volume is for instance a sensor, such as a level sensor,

In an further embodiment hereof, the system comprises means for activating/deactivating said means for supplying said aqueous ammonia solution as a function of the ratio between the determined volume of aqueous ammonia solution and the determined volume of ammonia precursor solution.

### INTRODUCTION OF FIGURES

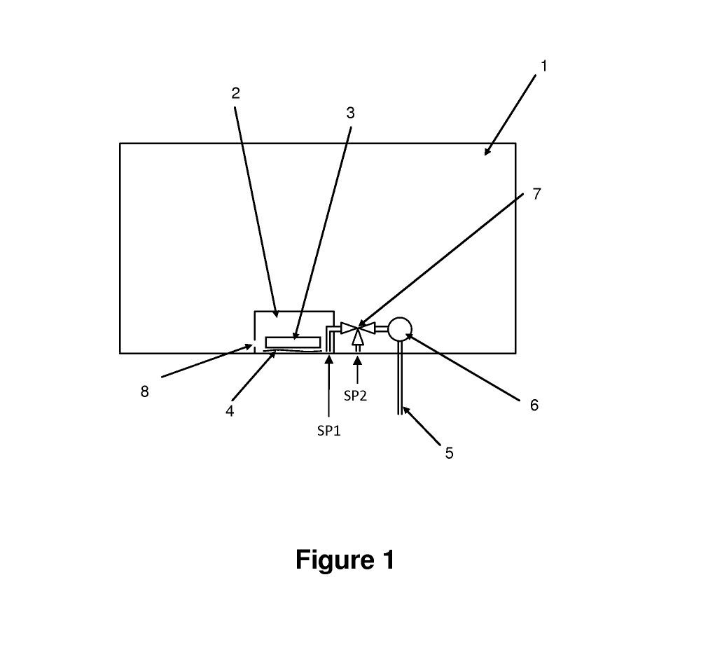

The present invention is illustrated in a non limitative way by the examples below relying on FIGS. 1 to 3 attached. In these figures, identical or similar devices bear identical reference numbers.

### DETAILED DESCRIPTION OF ILLUSTRATED EMBODIMENTS

The present invention pertains to the combined use of “AAUS” with “AUS” in static and mobile applications, for SCR or for other applications requiring ammonia or ammonia precursors such as fuel cells or usage as a fuel additive.

Under the acronym “AAUS”, we mean:
Aqueous Ammonia-Urea Solutions, containing a minimum of 0.2% in weight of ammonia
Any product containing at least 10% of Aqueous Ammonia/Urea Solutions as defined above.

Both Aqueous Ammonia-Urea Solutions and Aqueous Ammonia Solutions are therefore included under the acronym “AAUS”. Effluents of the conversion of AUS, and in particular AUS32 to ammonia are also included under the acronym “AAUS” provided the ammonia is generated at low temperatures (say <100° C.), for instance using biocatalyst. In a particular embodiment, effluents of the conversion of AUS can further be separated so as to eliminate CO2 or CO2 derivatives and/or water. For example, this can be done by a concentration device. For example, a membrane can be used to separate water from effluents of the conversion of AUS.

Similarly, we will designate by “AUS” Aqueous Urea Solutions, containing less than 0.2% in weight of ammonia, or any product containing at least 10% of such solution.

By combined use, we mean the use of at least 2 storage volumes or streams, at least one of which being dedicated to “AAUS”; the 2 storage volumes or streams can be used sequentially or simultaneously.

Such setup allows going around the above mentioned shortcomings of AUS32:
“AAUS” can contain low level of urea, and can therefore be injected in the exhaust pipe at lower temperatures than AUS32 without generating deposits. For instance, what we will refer to as AAUS22-0 (aqueous solution containing 22% in weight of ammonia and 0% in weight of urea) can be injected in the exhaust pipe without requiring further urea to ammonia conversion and without generating deposits. It is therefore attractive to use AAUS22-0 when the exhaust pipe is relatively cold, i.e. after start-up of the vehicle, so as to increase the NOx reduction performances. As the volumetric ammonia content of AAUS22-0 is practically the same as the ammonia generated by the same volume of AUS32, the dosing remains identical; such is also the case of AAUS 19-4, containing 19% weight of ammonia and 4% weight of urea, and of an infinity of intermediate combinations of adequate ammonia and urea quantities.
“AAUS” freezes at much lower temperatures than AUS32. For instance, AAUS22-0 remains liquid above −40° C., while AAUS19-4 does so above −35° C. Therefore, “AAUS” will remain liquid and available for NOx reduction at low temperatures, while AUS32 is frozen.
“AAUS” can also act as an anti-freezing agent for AUS32: for example 25 ml of AAUS22-0 can be mixed with 75 ml AUS32 and the resulting solution will not freeze above −15° C.
“AAUS” can also act as a thawing agent for AUS32: for example, at −15° C., 25 ml of AAUS22-0 can be injected in the frozen tank of AUS32, and will progressively thaw some amount of AUS32, say 75 ml. The resulting 100 ml will no longer freeze and the resulting solution is available for NOx reduction. Of course such thawing effect can be enhanced by circulation of the thawing agent (this is naturally the case in a vehicle thanks to the movement of the vehicle and the associated sloshing) and by local heating: for instance, a small heater can be located in the AUS32 tank near the point where the AAUS22-0 is injected, so that the heated mixture will rapidly thaw the surrounding AUS32, giving superior sustainability performances to the system.
The “AAUS” storage volume(s) can also provide an excellent protection against the freeze expansion. Storage volume(s) of “AAUS” with semi-flexible walls (for instance walls made of polymer such as polyethylene) can for instance be located inside the AUS32 storage volume, in the neighbourhood of the less robust mechanical components: the “AAUS” storage volume(s) will remain flexible and limit the forces generated by the freezing and the corresponding expansion of the AUS32 transmitted to the components, and to the AUS32 tank walls.

Moreover, “AAUS” is fundamentally compatible with “AUS”, in the sense that it contains the same molecules as “AUS” or the effluents of the conversion of “AUS” to ammonia. Actually, these effluents also contain carbon dioxide or carbon dioxide derivatives, which are detrimental for the NOx reduction performances; this is not generally the case for “AAUS” that is not generated directly by the decomposition of “AUS”.

However, as ammonia is toxic, so is the case for “AAUS”, and this is of special importance as the vapour pressures can be quite high: for instance, the partial vapour pressure of ammonia with AAUS22-0 (22% in weight of ammonia) is already 0.38 bar at 20° C. (total pressure=0.40 bar); at 80° C., the partial pressure becomes quite important as it reaches 3.2 bar (total pressure=3.6 bar); actually AAUS22-0 starts boiling around 44° C. in atmospheric pressure.

But for automotive applications, the advantages of “AAUS” over AUS32 are only important in specific circumstances, as already outlined above:
When the exhaust pipe is still relatively cold, so as to be able to start the NOx reduction process earlier or at low engine load to maintain the NOx reduction process;
When the temperature is below the freezing temperature of AUS32, or when AUS32 is still frozen.

As a consequence the need for “AAUS” is much lower than the need for AUS32. One can estimate that after a cold start, the delay between the time at which the adequate temperature for “AAUS” is reached and the time at which the adequate temperature for AUS32 is reached is about 7 minutes. Considering a consumption of 0.15 l/100 km AUS32 or “AAUS” (corresponding to 22.5 litres for 15000 km) and 500 cold starts during 15000 km, the consumption of “AAUS” associated with cold starts would be around 5 litres. A capacity of 7.5 litres for “AAUS” seems thus reasonable to meet the needs for the cold starts and additional distances to be covered in very cold conditions.

The storage volume for the “AAUS” can also be integrated in the volume occupied by the AUS32 so as to provide additional safety: in case of accident or leak, the system is designed so that the leaking “AAUS” will mix with the AUS32. This will further dilute the ammonia and reduce the corresponding vapour pressure. For instance, a dilution by a factor of 3 would bring the partial vapour pressure of ammonia at 20° C. from 0.38 bar to 0.08 bar; even at 60° C., the partial vapour pressure of ammonia of this diluted solution would be around 0.4 bar and the total vapour pressure around 0.6 bar. Such a protection can be achieved for instance by designing the storage system in such a way that the AUS32 volume partially or completely surrounds the volume of “AAUS”. Additionally the control system can insure that the remaining volume of “AAUS” does not exceed a given ratio of the total volume (combined “AAUS” and AUS32), for instance ⅓^{rd}; this can be done by forcing the consumption of “AAUS” whenever the ratio approaches its limit value.

Additional safety measures can also be taken through the selection of “AAUS” containing lower quantities of ammonia. This also allows to reduce the logistics and storage costs of the distribution networks. For instance, solutions with levels of ammonia below 20% are leaner in this respect, at least in the U.S., due to the specific requirements of EPA for solutions above 20%.

It should be noted that “AAUS” can also be obtained from the conversion of AUS32 at low temperatures using biocatalysts such as urease. A conversion unit can be integrated in the AUS32 tank as well as a buffer for the effluent which plays the role of the AAUS storage volume.

In the examples described below, the ammonia-consuming unit is an injector of a SCR system. Of course, in other applications the ammonia-consuming unit can be a fuel cell or an internal combustion engine.

### Embodiment 1

FIG. 1 is a schematic view of a liquid supply system according to a first particular embodiment of the present invention.

As illustrated in the example of FIG. 1, the system comprises:
a container (i.e. tank) [1] for the storage of an ammonia precursor solution;
a unit [2] for the storage of an aqueous ammonia solution; and
a pump [6] for supplying the aqueous ammonia solution to an ammonia-consuming unit (not represented), for example an injector of a SCR system.

In the example of FIG. 1, the unit [2] is provided with means for decomposing one part of the ammonia precursor solution stored in the tank [1]. This unit [2] is called hereafter “decomposition and storage unit”

In a particular embodiment, the tank [1] stores an aqueous urea solution, for example AdBlue® solution (commercial solution of urea).

In the example of FIG. 1, the decomposition and storage unit [2] comprises a bio-agent [3] (i.e. protein component or protein sequence). This bio-agent is adapted to decompose the urea stored in tank [1]. More precisely, the bio-agent [3] is adapted to convert the urea into an aqueous ammonia solution (called hereafter aqua ammonia). For example, an enzyme, such as urease, can be used to decompose the urea. Of course, other suitable protein sequence can be used. Advantageously, the bio-agent [3] (for example, urease) is immobilized on a support. For example, the support can be a natural or synthetic organic polymer or an inorganic material (such as porous silica, clay, activated carbon, for example). The support can be in the form of a membrane or a layer of resin or granules.

As illustrated, the decomposition and storage unit [2] comprises a heater [4] adapted to thermally activate the enzyme [3]. Advantageously, the heater [4] can also be used to defreeze the urea solution (especially for vehicle key on (i.e. engine start-up) at low temperature).

The pump [6] is configured to transport the urea or the aqua ammonia to an injector (not represented) via a feed line [5]. The injector injects the urea or the aqua ammonia in the exhaust gases for NOx removal. In the example of FIG. 1, the pump [6] is connected to a first suction point [SP1] located inside the decomposition and storage unit [2] and to a second suction point [SP2] located inside the tank [1]. Advantageously, the pump is connected to the first and second suction points via a 3-way valve [7].

For example, in cold conditions, if at vehicle start-up the urea solution is not available (i.e. not enough urea in liquid state) because it is frozen or if it is desired to meter reducing agent very early while the exhaust pipe is still relatively cold, then the 3-way valve [7] is switched so that the connection between the pump [6] and the first suction point [SP1] is opened and the connection between the pump [6] and the second suction point [SP2] is closed. In this configuration, the pump [6] is used to pump at a required pressure the aqua ammonia stored in the decomposition and storage unit [2]. The aqua ammonia is then injected into the exhaust gases. For example, while metering aqua ammonia into the exhaust gases, a specific heater (not illustrated) located inside the tank [1] can be activated to defreeze the urea solution. When the urea solution becomes available (after thawing), the 3-way valve [7] is switched so that the connection between the pump [6] and the second suction point [SP2] is opened and the connection between the pump [6] and the first suction point [SP1] is closed.

On the other hand, if at vehicle start-up the urea solution is available and if the exhaust temperature is already relatively high, for instance above 180° C., then the 3-way valve [7] is switched so that the connection between the pump [6] and the second suction point [SP2] is opened and the connection between the pump [6] and the first suction point [SP1] is closed. In this configuration, the pump [6] is used to pump at a required pressure the urea solution stored in the tank [1]. The urea solution is then injected into the exhaust gases.

At the end of operation, when the vehicle stops, the 3-way valve [7] is switched back so that the connection between the pump [6] and the first suction point [SP1] is opened and the connection between the pump [6] and the second suction point [SP2] is closed; as a result, aqua ammonia is introduced in the line to the exhaust pipe.

In the particular embodiment illustrated in FIG. 1, the decomposition and storage unit [2] comprises an inlet [8] through which the urea solution can enter. In this way, the decomposition and storage unit [2] can be automatically re-filled with urea solution, for aqua ammonia production.

Advantageously, the inlet [8] can comprise a check valve (not illustrated) configured to prevent the produced aqua ammonia to flow back into tank [1].

In a particular embodiment, the system can be equipped with a port (i.e. an access) to allow the bio-agent [3] renewal.

In a particular embodiment, the decomposition and storage unit [2] is a module that is mounted in a sealed manner at the bottom of the tank [1]. Advantageously, this module comprises connection means which allow it to be easily plugged to and unplugged from the tank [1]. For example, a cam lock system or a mason jar system can be used for this purpose.

In another embodiment, the support on which the bio-agent [3] is immobilized can be plugged/unplugged from the tank [1].

Advantageously, the decomposition and storage unit [2] can be surrounded by thermal isolation or by phase change materials (PCM) or can contain PCM material, so that the ammonia precursor solution present in the unit [2] at engine stop continues to be decomposed while the vehicle is at rest, so that aqua ammonia will be available for the next start-up of the engine.

### Embodiment 2

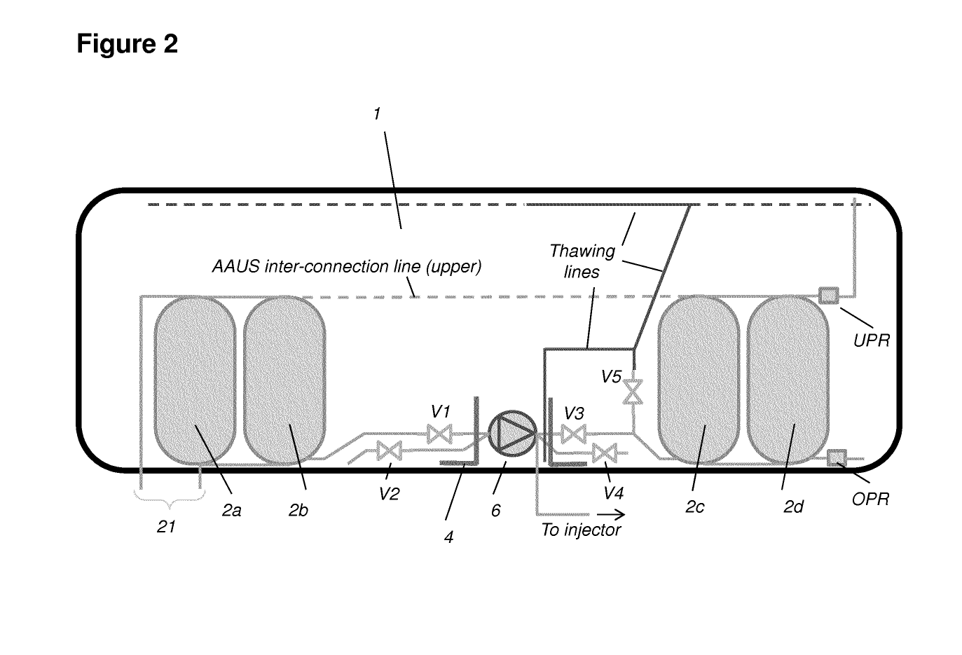

FIG. 2 is a schematic view of a liquid supply system according to a second particular embodiment of the present invention.

The system illustrated in the example of FIG. 2 is composed of a tank [1] for AUS32; this tank is equipped with a conventional filling and venting system as known in the state of the art, and not represented on this figure.

4 tanks [2a, 2b, 2c, 2d] dedicated to the “AAUS” are integrated in the AUS32 tank [1]; these tanks [2a, 2b, 2c, 2d] are designed so as to resist to the vapour pressure of “AAUS”; these tanks [2a, 2b, 2c, 2d] are interconnected in their upper parts and their lower parts (lower interconnection not fully represented for the clarity of the figure), so as to form a single storage volume and allow transfer of liquid and vapour. The storage volume constituted by these tanks [2a, 2b, 2c, 2d] are also fitted with a specific filling interface [21], combining both liquid supply and vapour recovery line, allowing an operator (i.e. user) not to be exposed to ammonia vapour; both lines can be integrated in a single interface (not represented) as already known for the supply of gaseous fluids and noxious fluids.

The 4 “AAUS” tanks [2a, 2b, 2c, 2d] are immersed in the AUS32, so that the “AAUS” will mix with the AUS32 in case of leak, reducing considerably the partial pressure of ammonia. They are also equipped with an Over Pressure Relieve valve (OPR) that will evacuate some “AAUS” in the AUS32 in case of overpressure, and Under Pressure Relieve valve (UPR) that will suck vapour in case of vacuum. This UPR can be calibrated in such a way as to preserve some vacuum in the “AAUS” storage volume, so that no ammonia vapour escapes in case a leak would appear in the vapour dome of the “AAUS” storage volume; for instance, the UPR can be designed so as to only open when the pressure in the “AAUS” storage vapour dome is 0.5 bar below the pressure in the AUS32 vapor dome.

Like conventional AUS32 systems, the AUS32 tank [1] is equipped with a pump [6] to send the fluids to the injector and exhaust pipe. However the pump [6] can be fed either with “AAUS”, when valve V1 is open, or with AUS32 (when valve V2 is open). Valves V1 and V2 could actually be replaced by a 3-ways valve (not represented here), or share an actuator. Part of the flow coming out of the pump [6] does not go to the injector and is redirected either to the “AAUS” storage volume (through valve V3) or to the AUS32 storage volume (through valve V4).

Like conventional AUS32 systems, the AUS32 tank [1] is equipped with a heater [4], but this heater [4] can be much smaller than on a conventional AUS32 tank for a given de-icing performance: while operating with “AAUS” in cold conditions, valve V3 will be open, and valve V5 can also be opened so as to mix some “AAUS” with the AUS32 through the thawing lines, eventually equipped with calibrated orifices (not shown); part of this thawing flow of “AAUS” is directed to the vicinity of the heater so as to be heated and have additional thawing capability when coming in contact with the frozen AUS32 contained in the AUS32 tank; the sloshing movements of the fluid while the vehicle is in movement together with the flow or spray of “AAUS” coming from the upper part of the thawing lines insure progressive thawing of the AUS32.

Contrary to a conventional AUS32 system, the lines coming from the tank to the injector do not need to be heated, as the system is operated with “AAUS” when the temperature is too low and could result in the freezing of AUS32.

Despite the presence of ammonia into “AAUS”, the storage system is quite safe thanks to the double containment effect associated with the embedding of the “AAUS” storage volume inside the AUS32 storage volume.

Advantageously, a consumption/refill strategy can be deployed so as to avoid the most critical situations. Actually, the analysis of the impact of leakages reveals that 2 types of situation are critical. On one hand, when the AUS32 storage volume is almost empty, a relatively high partial pressure of ammonia could appear in the vapour dome of the AUS32 storage volume in case the “AAUS” would flow through a leak in the AUS32 storage volume, especially if the “AAUS” volume is still almost full. On the other hand, when the AUS32 storage volume is almost full while the “AAUS” storage volume is almost empty, a leak in the vapour dome of the “AAUS” storage volume could result in the transfer of a large volume at high partial pressure of ammonia into the reduced vapour dome of the AUS32 storage volume, and from there to the outside. A strategy consisting in keeping the amount of “AAUS” within a given ratio of the amount of AUS32, say between 1/10^{th} and ⅔, and ideally between ¼^{th} and ½th allows to insure that leakages would not result in situations dangerous for life or health; for instance, a strategy can be deployed so as to maintain the level of NH3 ppm below 30 ppm and even below 10 ppm in case the system would leak. The strategy consists in forcing the consumption of “AAUS” whenever the volume of “AAUS” tends to become too important versus the volume of AUS32, and inversely to avoid consuming “AAUS” if its volume is becoming too low. In addition, requests for refill of AUS32, or eventually “AAUS” can be generated by the control unit or even enforced, but this would be quite exceptional as realistic strategies and design of the system allow maintaining the ratio within the appropriate range.

In a particular embodiment, the operations (i.e. functioning) of the liquid supply system of FIG. 2 can be managed by a controller (not represented).

For example, when the vehicle is started, following some delay after key-on, V1 and V3 are opened, V2, V4 and V5 are closed, and the pump is activated so that the SCR system operates in “AAUS” mode.

When the temperature in the exhaust pipe, as measured by a sensor or derived from a model is sufficient (say 120° C.), or when this temperature is sufficient and that a given delay since key-on is exceeded, the injection is started.

When the temperature in the exhaust pipe reaches a second threshold value (say 180° C.) and that the external temperature (as measured by another sensor not represented) is above a third threshold value (say −5° C.), and if the available volume of “AAUS” does not exceed a limit fraction (say 33%) of the available total volume (“AAUS”+AUS32) (as measured by gauges in the “AAUS” and AUS32 storage volumes and not represented on the figure), the SCR system is switched from “AAUS” mode to AUS32 mode by closing V1 and opening V2, and after some short delay closing V3 and opening V4.

During operation, the mode can be switched from AUS32 mode back to “AAUS” mode if the external temperature drops below a fourth threshold value (say −5° C.) and/or the temperature of the AUS32 solution (as measured by a temperature sensor inside the AUS32 storage volume) falls below a fifth threshold value (say −5° C.) or if the available volume of “AAUS” starts to exceed a limit fraction (say 33%) of the available total volume (“AAUS”+AUS32). This is done by opening V1 and closing V2, and after some delay (so as to avoid the contamination of the “AAUS” storage volume with AUS32) opening V3 and closing V4.

If the temperature rises again during operation, depending on threshold values on the external temperature and the temperature of the AUS32 solution and the ratio of the respective volumes of “AAUS” and total volume (“AAUS”+AUS32), the mode can be switched from “AAUS” mode to AUS32 mode, by closing V1 and opening V2, and after some short delay closing V3 and opening V4.

While operating in “AAUS” mode, the SCR system can be switched to “AAUS-Thawing” mode based on conditions on the external temperature, AUS32 temperature, available volumes of “AAUS” and AUS32 (as measured by gauges in the “AAUS” and AUS32 storage volumes and not represented on the figure) and the estimation of the quantity of “AAUS” already injected in the AUS32 storage volume and the associated ammonia concentration in the AUS32. This is done by opening V5 and activating the heater (if not already done on the same basis as for a conventional AUS32 control system). The conditions to activate the “AAUS-Thawing” mode can be that the “AAUS” available volume is within a given absolute range (say 1 to 7.5 litres) and a relative range (say 15% to 33% of the total available volume (“AAUS”+AUS32)), that the external temperature is within a given range (say −20° C. to −5° C.) and/or that the AUS32 temperature is also within a given range (say −20° C. to −5° C.) and that the estimated concentration of ammonia in the AUS32 does not exceed a threshold value. The amount of “AAUS” injected in the AUS32 storage volume is estimated thanks to a timer, and the concentration of ammonia is estimated based on a model of the addition of “AAUS” and the consumption of the “AAUS”-AUS32 mixture. Alternatively or in complement, the amount of “AAUS” injected in the AUS32 storage can be measured through a sensor (not represented) placed in the AUS32 storage volume, for instance a sensor measuring the electrical conductivity as the conductivity of the resulting mixture is very sensitive to the amount of ammonia.

While operating in “AAUS-Thawing” mode, the SCR system can be switched to “AAUS” mode if the conditions enabling that mode are no longer met, or based on another set of conditions/parameters.

Whenever the remaining volume of “AAUS” falls below a threshold value, the control system (not shown) can start a warning procedure to prompt the refilling of the “AAUS” storage volume; eventually, if the level becomes too critical, the vehicle can be switched to a degraded operation mode.

At key-off, if the SCR system is in AUS32 mode or if it is in “AAUS” or “AAUS-Thawing” modes and if these latter 2 modes have only been activated for a short period, a purge of the line from the pump to the injector is performed in a similar way as on a conventional AUS32 system: valve V1 is closed, V2 is opened, V3, V4 and V5 are closed, and the pump is activated in reverse mode so as to suck the content of the line and send it back to the AUS32 storage volume. The purge is not activated if the line is completely filled with “AAUS”, as the “AAUS” will not freeze; this allows saving some “AAUS”. The filling of the line with “AAUS” is modelled based on the amount injected since the “AAUS” or “AAUS-Thawing” modes have been initiated and the volume of the line.

### Embodiment 3

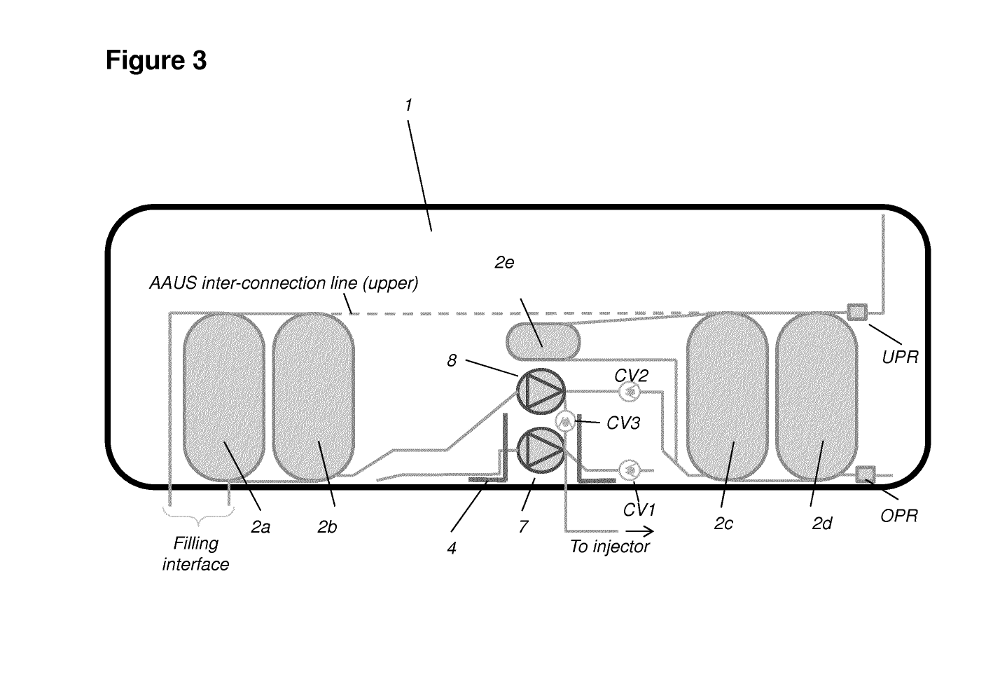

FIG. 3 is a schematic view of a liquid supply system according to a third particular embodiment of the present invention.

The system illustrated in the example of FIG. 3 is composed of a tank [1] for AUS32; this tank [1] is equipped with a conventional filling and venting system as known in the state of the art, and not represented on this figure.

5 tanks [2a, 2b, 2c, 2d, 2e] dedicated to the “AAUS” are integrated in the AUS32 tank [1]. The 5^{th} tank of “AAUS” [2e] has flexible walls and is configured to protect components from the compression resulting from the ice expansion occurring when AUS32 freezes.

Like conventional AUS32 systems, the AUS32 tank is equipped with a AUS32 pump [7] to send the fluids to the injector and exhaust pipe. However a second pump [8] is dedicated to the “AAUS”. When “AAUS” needs to be delivered to the injector, the AAUS pump [8] is activated while opening the check-valves CV2 and CV3 but not CV1 (as it opens at larger pressures than CV2) and the AUS32 pump [7] is stopped; this pump [7] does not allow reverse flow when it is not activated. When AUS32 needs to be delivered to the injector, the AAUS pump [8] is stopped and the AUS32 pump [7] is activated; CV1 is open as the pressure delivered by the AUS32 pump is sufficient, while CV2 and CV3 remain closed. In a particular embodiment, only the AUS32 pump [7] can be activated in reverse mode for purging; in that case, the AUS32 pump is sucking the content of the line to the injector and sends it back to the AUS32 tank; CV1 and CV2 are closed, and CV3 will remain closed as well as the vacuum provoked by the AUS32 pump is not sufficient to open it.

The AAUS pump [8] can be replaced by any device capable of pressurizing and transferring “AAUS”.

Like conventional AUS32 systems, the AUS32 tank is equipped with a heater [4], but this heater can be much smaller than on a conventional AUS32 tank for a given de-icing performance: while operating with “AAUS” in cold conditions, the AUS32 pump can be activated in slow reverse mode so as to send some “AAUS” to the AUS32 tank, in the vicinity of the heater so as to be heated and have additional thawing capability when coming in contact with the frozen AUS32 contained in the AUS32 tank; the sloshing movements of the fluid while the vehicle is in movement insure progressive thawing of the AUS32.

Contrary to a conventional AUS32 system, the lines coming from the tank to the injector do not need to be heated, as the system is operated with “AAUS” when the temperature is too low and could result in the freezing of AUS32.

In a particular embodiment, the operations (i.e. functioning) of the liquid supply system of FIG. 3 can be managed by a controller (not represented).

For example, when the vehicle is started, following some delay after key-on, the AAUS pump is activated while maintaining the AUS32 pump stopped, so that the SCR system operates in “AAUS” mode.

When the temperature in the exhaust pipe, as measured by a sensor or derived from a model is sufficient (say 120° C.), or when this temperature is sufficient and that a given delay since key-on is exceeded, the injection is started.

When the temperature in the exhaust pipe reaches a second threshold value (say 180° C.) and that the external temperature (as measured by another sensor not represented) is above a third threshold value (say −5° C.), and if the available volume of “AAUS” does not exceed a limit fraction (say 33%) of the available total volume (“AAUS”+AUS32) (as measured by gauges in the “AAUS” and AUS32 storage volumes and not represented on the figure), the SCR system is switched from “AAUS” mode to AUS32 mode by stopping AAUS Supply System and activating the AUS32 pump.

During operation, the mode can be switched from AUS32 mode back to “AAUS” mode if the external temperature drops below a fourth threshold value (say −5° C.) and/or the temperature of the AUS32 solution (as measured by a temperature sensor inside the AUS32 storage volume) falls below a fifth threshold value (say −5° C.) or if the available volume of “AAUS” starts to exceed a limit fraction (say 33%) of the available total volume (“AAUS”+AUS32). This is done by stopping the AUS32 pump and activating the AAUS Supply System.

If the temperature rises again during operation, depending on threshold values on the external temperature and the temperature of the AUS32 solution and the ratio of the respective volumes of “AAUS” and total volume (“AAUS”+AUS32), the mode can be switched from “AAUS” mode to AUS32 mode, by stopping AAUS Supply System and activating the AUS32 pump.

While operating in “AAUS” mode, the SCR system can be switched to “AAUS-Thawing” mode based on conditions on the external temperature, AUS32 temperature, available volumes of “AAUS” and AUS32 (as measured by gauges in the “AAUS” and AUS32 storage volumes and not represented on the figure) and the estimation of the quantity of “AAUS” already injected in the AUS32 storage volume and the associated ammonia concentration in the AUS32. This is done by activating the heater (if not already done on the same basis as for a conventional AUS32 control system) and the AUS32 pump in slow reverse mode. The conditions to activate the “AAUS-Thawing” mode can be that the “AAUS” available volume is within a given absolute range (say 1 to 7.5 litres) and a relative range (say 15% to 33% of the total available volume (“AAUS”+AUS32)), that the external temperature is within a given range (say −20° C. to −5° C.) and/or that the AUS32 temperature is also within a given range (say −20° C. to −5° C.) and that the estimated concentration of ammonia in the AUS32 does not exceed a threshold value. The amount of “AAUS” injected in the AUS32 storage volume is estimated thanks to a timer, and the concentration of ammonia is estimated based on a model of the addition of “AAUS” and the parameters of the injector, the AUS32 pump and the AAUS Supply System. Alternatively or in complement, the amount of “AAUS” injected in the AUS32 storage can be measured through a sensor (not represented) placed in the AUS32 storage volume, for instance a sensor measuring the electrical conductivity as the conductivity of the resulting mixture is very sensitive to the amount of ammonia.

While operating in “AAUS-Thawing” mode, the SCR system can be switched to “AAUS” mode if the conditions enabling that mode are no longer met, or based on another set of conditions/parameters.

Whenever the remaining volume of “AAUS” falls below a threshold value, the control system (not shown) can start a warning procedure to prompt the refilling of the “AAUS” storage volume; eventually, if the level becomes too critical, the vehicle can be switched to a degraded operation mode.

At key-off, if the SCR system is in AUS32 mode or if it is in “AAUS” or “AAUS-Thawing” modes and if these latter 2 modes have only been activated for a short period, a purge of the line from the pump to the injector is performed as follows: the AAUS Supply System is stopped and the AUS32 is activated in reverse mode so as to suck the content of the line and send it back to the AUS32 storage volume. The purge is not activated if the line is completely filled with “AAUS”, as the “AAUS” will not freeze; this allows saving some “AAUS”. The filling of the line with “AAUS” is modelled based on the amount injected since the “AAUS” or “AAUS-Thawing” modes have been initiated and the volume of the line.

1-6. (canceled)

7: A liquid supply system for at least one ammonia-consuming unit mounted on board a vehicle, comprising:
a container for storage of an ammonia precursor solution;
at least one unit for storage of an aqueous ammonia solution containing at least 0.2% in weight of ammonia in water;
means for supplying the aqueous ammonia solution to the ammonia-consuming unit;
wherein the at least one unit is located at least partially inside the container and/or on a wall of the container.

8: A liquid supply system according to claim 7, further comprising means for supplying the ammonia precursor solution to the ammonia-consuming unit.

9: A liquid supply system according to claim 7, wherein the aqueous ammonia solution contains aqueous urea solution or residue of aqueous urea solution.

10: A liquid supply system according to claim herein the aqueous ammonia solution contains carbon dioxide or carbon dioxide derivatives.

11: A liquid supply system according to claim 9, wherein the aqueous ammonia solution is a mixture of effluents containing ammonium hydroxide, residue of ammonia precursor solution, carbon dioxide and/or carbon dioxide derivatives.

12: A liquid supply system according to claim 10, wherein the aqueous ammonia solution is a mixture of effluents containing ammonium hydroxide, residue of ammonia precursor solution, carbon dioxide and/or carbon dioxide derivatives.

13: A liquid supply system according to claim 11, further comprising means for obtaining the mixture of effluents by decomposing one part of the ammonia precursor solution stored in the container, by at least one enzyme or urease.

14: A liquid supply system according to claim 12, further comprising means for obtaining the mixture of effluents by decomposing one part of the ammonia precursor solution stored in the container, by at least one enzyme or urease.

15: A liquid supply system according to claim 7, wherein the at least one unit comprises at least one refilling port being in fluid communication with a filler pipe.

16: A liquid supply system according to claim 7, wherein the at least one unit comprises at least one venting port being in fluid communication with a venting circuit.

17: A liquid supply system according to claim 16, wherein the venting circuit comprises at least one of an Over Pressure Relieve valve or an Under Pressure Relieve valve.

18: A liquid supply system according to claim 7, further comprising at least one line configured to transport the aqueous ammonia solution from the at least one unit to interior of the container, and controllable means for metering the aqueous ammonia solution in the at least one line.

19: A liquid supply system according to claim 7, wherein the at least one unit is entirely located inside the container.

20: A liquid supply system according to claim 7, wherein at least one part of the at least one unit is flexible, or the at least one part of the at least one unit is made of polymer or polyethylene.

21: A liquid supply system according to claim 7, further comprising means for determining volume of aqueous ammonia solution stored in the at least one unit and volume of ammonia precursor solution stored in the container.

22: A liquid supply system according to claim 19, further comprising means for activating/deactivating the means for supplying the aqueous ammonia solution as a function of ratio between the determined volume of aqueous ammonia solution and the determined volume of ammonia precursor solution.
